(19) United States
(12) Patent Application Publication
(10) Pub. No.: US 2010/0187736 A1
(43) Pub. Date: Jul. 29, 2010

(54) MAGNETIC TURNTABLE SYSTEM AND METHOD

(76) Inventor: Ellen Hutson, Issaquah, WA (US)

Correspondence Address: GRAYBEAL JACKSON LLP, 400 - 108TH AVENUE NE, SUITE 700, BELLEVUE, WA, 98004, US

(21) Appl. No.: 12/691,874

(22) Filed: Jan. 22, 2010

Related U.S. Application Data
(60) Provisional application No. 61/146,977, filed on Jan. 23, 2009.

(51) Int. Cl. B25B 11/00

(52) U.S. Cl. 269/8; 269/290

(57) ABSTRACT

A magnetic turntable system is described and shown.

### PRIORITY CLAIM

This application claims the benefit of U.S. Provisional Application No. 61/146,977 filed on Jan. 23, 2009, which application is incorporated herein by reference in its entirety for all purposes.

### FIELD

This disclosure relates generally to work surfaces, and more specifically, to systems and methods for providing a magnetic turntable.

### BACKGROUND

For artists and designers, a flat surface is an essential tool when drawing, cutting, painting, and the like. Additionally, many artists, architects and designers use various stencils, rulers, and masks to assist in such drawing, cutting and painting. For example, a designer drawing a line will use a ruler or straight edge to form such a line. In another example, an artist airbrushing a design may use a stencil to cover portions of a medium that will not receive paint.

Commonly, users of such tools must hold the tools or their work in place using their hands, a press, an adhesive, tape, or via gravity alone. Regardless, techniques such as physical holding and gravity are vulnerable to slipping and adhesives, tape and presses can damage portions of a work.

Additionally, artists and designers tend to interact with their work at various angles and in various directions, which typically requires the artist or designer to contort their body, move the work, or move the surface on which a work may be positioned. Unfortunately, moving a work can damage it and is not always compatible with simultaneous use of the tools described above. Contorting one's body is also not desirable because it typically reduces the dexterity and comfort of the artist, which may compromise the quality of the work being done. Moreover, even simple movements may not be possible for some individuals such as the elderly or those with disabilities, and these groups of people may be unable to create certain artwork or crafts without tools that assist them with holding a workpiece.

### BRIEF DESCRIPTION OF THE DRAWINGS

The present disclosure will be presented by way of exemplary embodiments but not limitations, illustrated in the accompanying drawings in which like references denote similar elements, and in which:

FIG. 1a is a top view of a magnetic turntable in accordance with one embodiment.

FIG. 1b is a top view of a magnetic turntable in accordance with another embodiment.

FIG. 2a is a top view of a magnetic turntable in accordance with a further embodiment.

FIG. 2b is a top view of a magnetic turntable in accordance with a still further embodiment.

FIG. 3a is a side view of a magnetic turntable in accordance with an embodiment.

FIG. 3b is a side view of a magnetic turntable in accordance with another embodiment.

FIG. 3c is a side view of a magnetic turntable in accordance with a further embodiment.

FIG. 4a is a bottom view of a top portion of a magnetic turntable in accordance with one embodiment.

FIG. 4b is a bottom view of a top portion of a magnetic turntable in accordance with another embodiment.

FIG. 5a is a top view of the bottom portion of a magnetic turntable in accordance with one embodiment.

FIG. 5b is a top view of the bottom portion of a magnetic turntable in accordance with another embodiment.

FIG. 6 is a top view of a magnetic turntable axle in accordance with one embodiment.

FIG. 7 is a side view of a magnetic turntable axle in accordance with one embodiment.

FIG. 8 is a side view of a magnetic turntable holding a workpiece via a work tool in accordance with one embodiment.

FIG. 9 is side view of a magnetic turntable holding a workpiece via a work tool in accordance with a further embodiment.

FIG. 10 is a block diagram of a method of holding a workpiece in accordance with one embodiment.

FIG. 11 is a block diagram of another method of holding a workpiece in accordance and further embodiment.

### DESCRIPTION

Illustrative embodiments presented herein include, but are not limited to, systems and methods for providing a magnetic turntable.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order to not obscure the illustrative embodiments.

Further, various operations will be described as multiple discrete operations, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

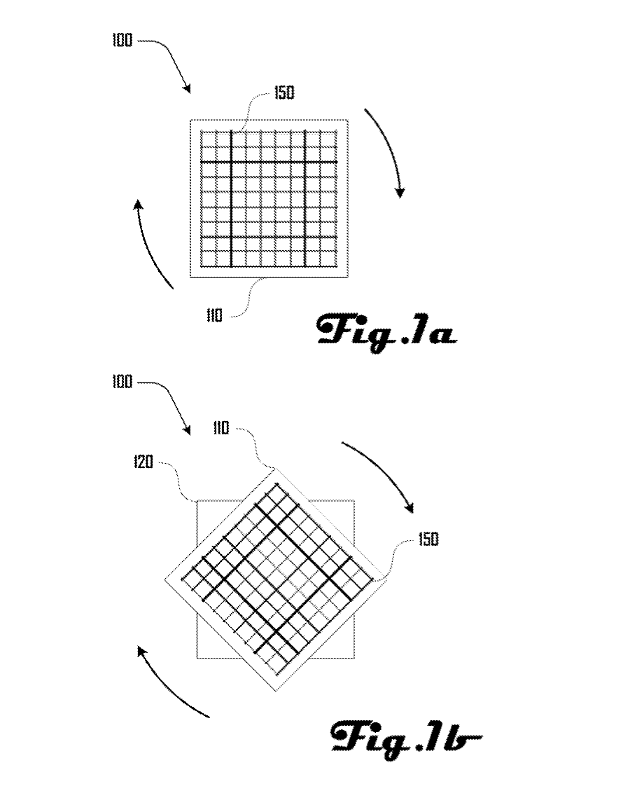

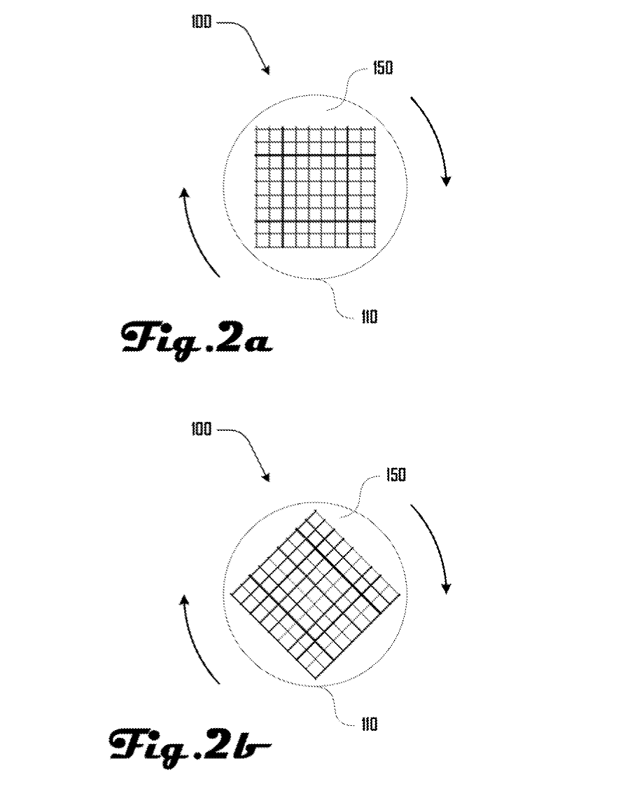

FIGS. 1a, 1b, 2a, and 2b depict a top view of a magnetic turntable 100 in accordance with various embodiments. The magnetic turntable 100 may rotate about a central axis (via an axle 310 as shown and described in further figures) and the magnetic turntable 100 may include a top portion 110 and a base portion 120. The top surface of the top portion 110 is the workface 150. FIGS. 1a and 1b depict a magnetic turntable 100 that is rectangular in shape and FIGS. 2a and 2b depict a magnetic turntable 100 that is circular in shape.

As shown in FIGS. 1a, 1b, 2a, and 2b, the workface 150 of the top portion 110 of the magnetic turntable 100 may include a grid or other image. In various embodiments, a grid or the like may be present; however, in some embodiments, other designs or images may be present on the top portion 110, or such designs or images may be absent. In some embodiments, the magnetic turntable 100 may comprise various materials such as plastic, metal, wood, a composite material, and the like. Additionally, in various embodiments, the magnetic turntable 100 may comprise a self-healing cutting mat.

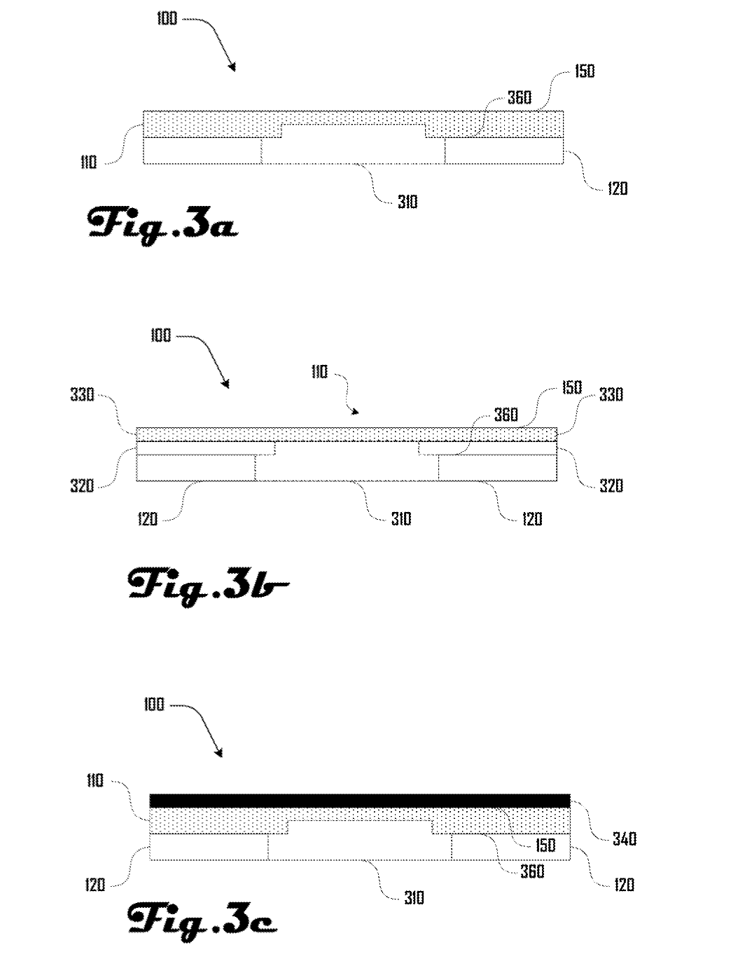

FIGS. 3a, 3b and 3c depict a side view of a magnetic turntable 100 in accordance with various embodiments. Some embodiments comprise a top portion 110, a base portion 120, and an axle 310. In some embodiments, the top portion 110 comprises a magnetic member 330 and a base member 320. In some embodiments the magnetic turntable 100 may comprise a metallic top plate 340.

FIG. 3a is a side view of a magnetic turntable 100 in accordance with an embodiment, which comprises a top portion 110, a base portion 120 and an axle 310. The top portion 110 comprises an opposing work face 150 and coupling face 360. Additionally, as shown in FIG. 3a, a part of the axle 310 may reside within the base portion 120, and a part of the axle 310 may reside within a coupling orifice 410 defined by the top portion 110. In various embodiments, the axle 310 facilitates rotation of the top portion 110 about the axle 310, and creates a rotational coupling of the top portion 110 and the base portion 120. Such a rotational coupling may provide for at least 360° of rotation of the top portion 110 about the axle 310. Exemplary rotation is depicted in FIGS. 1a, 1b, 2a, and 2b.

In some embodiments, the top portion 110 may be magnetic, and thereby allow metallic objects, metalized objects, and/or magnetized objects to couple with the top portion 110. In various embodiments, the top portion 110 is uniformly magnetic, but need not be uniformly magnetic in some embodiments. In some embodiments, the axle 310 and/or base portion 120 may be magnetized. In other embodiments, any of the axle 310, base portion 120 and top portion 110 may be coupled via magnetism, an adhesive, a slot and pin, friction fit, and the like.

FIG. 3b is a side view of a magnetic turntable 100 in accordance with another embodiment, which comprises an axle 310, a base portion 120, and a top portion 110 that comprises a magnetic member 330 and a base member 320. In some embodiments, the magnetic member 330 and the base member 320 may be coupled via an adhesive, magnetism, or the like. As shown in FIG. 3b, the base member 320 may define a coupling orifice 410 which corresponds to a portion of the axle 310, which allows the top portion 110 to couple with the axle 310, by allowing a portion of the axle 310 to reside within the base member orifice 510.

In some embodiments, the magnetic member 330 may also define a coupling orifice 410 wherein the axle 310 may reside. In various embodiments, the magnetic member 330 may comprise various materials, some of which may be magnetic and some of which may not be magnetic. For example, the magnetic member 330 may comprise plastic, metal, a magnetized material, wood, and the like.

FIG. 3c is a side view of a magnetic turntable 100 in accordance with an embodiment, which comprises a top portion 110, a base portion 120, a metallic top plate 340, and an axle 310. As shown in FIG. 3c, a part of the axle 310 may reside within the base portion 120, and a part of the axle 310 may reside within the coupling orifice 410 of the top portion 110. In various embodiments, the axle 310 facilitates rotation of the top portion 110 about the axle 310, and creates a rotational coupling of the top portion 110 and the base portion 120. Exemplary rotation is depicted in FIGS. 1a, 1b, 2a, and 2b.

In some embodiments, the top portion 110 may be magnetic, and thereby allow metallic objects, metalized objects, and/or magnetized objects to couple with the top portion 110. For example, the metallic top plate 340 may comprise a metal and may be capable of being magnetically coupled to the top portion 110. In various embodiments, it may be desirable for the metallic top plate 340 to be removable so as to allow magnetized objects to couple with the metallic top plate 340 when attached, or so as to allow metallic objects to couple with the work face 150 of the top portion 110, when the metallic top plate 340 is not present.

In such embodiments, such metallic objects may include various metallic and/or magnetic objects, which may be tools relating to arts and crafts. For example, a metal stencil may be placed on a piece of paper that is on the magnetic turntable 100, and the metal stencil and paper may be held to the workface 150 of the magnetic turntable 100 via magnetism. In such an example, a user may choose to paint, cut or draw on the paper. Additionally, the user may rotate the top portion 110 of the magnetic turntable 100, and in various embodiments, the magnetism holding the metal stencil to the workface 150 of the magnetic turntable 100 may prevent movement of the piece of paper.

In another example, wherein the magnetic turntable 100 comprises a metallic top plate 340 or the top portion 110 comprises metallic portions, magnets or magnetized stencils may be used as described above relating to metallic stencils.

In some embodiments, the axle 310 and/or base portion 120 may be magnetized. In other embodiments, any of the axle 310, base portion 120, metallic top plate 340, and top portion 110 may be coupled via magnetism, an adhesive, a slot and pin, friction fit, and the like.

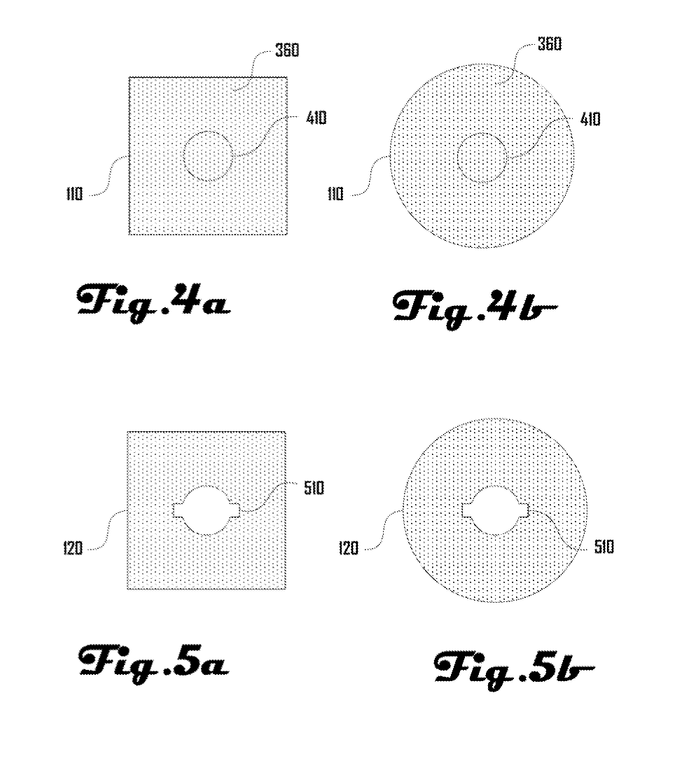

FIGS. 4a and 4b depict a bottom view of a top portion 110 of a magnetic turntable 100 in accordance with various embodiments. FIG. 4a depicts a top portion 110 having a rectangular shape and FIG. 4b depicts a top portion 110 having a circular shape. The top portion 110, comprises a coupling orifice 410, which is a cavity defined by the top portion 110, in which an axle 310 may reside.

In some embodiments, the coupling orifice 410 may be defined by a top portion 110. In further embodiments, the coupling orifice 410 may be defined by a magnetic member 330 and/or a magnetic base member 320. In further embodiments, the coupling orifice 410 may be various shapes and sizes.

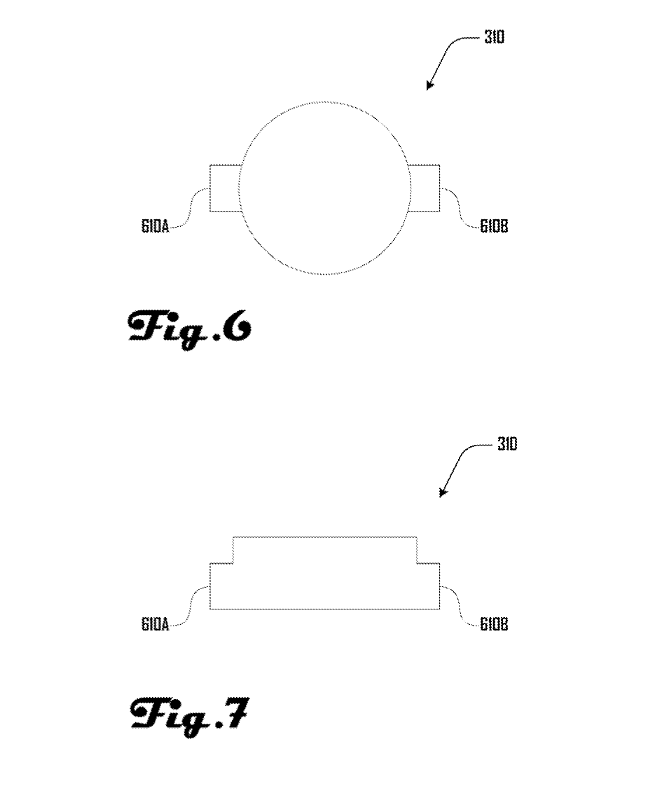

FIGS. 5a and 5b depict a top view of the base portion 120 of a magnetic turntable 100 in accordance with some embodiments. FIG. 5a depicts a base portion 120 having a rectangular shape and FIG. 5b depicts a base portion 120 having a circular shape. The base portion 120 comprises an axle orifice 510, which is defined by the base portion 120.

As shown in FIGS. 5a and 5b, the axle orifice 510 may be circular with rectangular portions extending from an equator of the circle. In some embodiments, the rectangular portions may correspond to various portions of an axle 310. In further embodiments, the axle orifice 510 may be various shapes and sizes, and may correspond to various structures of an axle 310. In still further embodiments, the axle orifice 510 may not extend entirely through the base portion 120.

FIG. 6 is a top view of a magnetic turntable axle 310 in accordance with one embodiment and FIG. 7 is a side view of a magnetic turntable axle 310 in accordance with another embodiment. As depicted in these embodiments, the axle 310 has a cylindrical portion and a first and second axle flange 610A, 610B which extend therefrom. In various embodiments, the first and second axle flange 610A, 610B may correspond to portions of an axle orifice 510 (as shown in FIGS. 5a and 5b). Such a correspondence may be desirable in various embodiments, because it may allow the axle 310 to be locked in place when residing within a base portion 120, yet allow the top portion 110 of a magnetic turntable 100 to rotate about a central axis of the axle 310, when the axle 310 resides within the top portion 110.

In some embodiments, there may be one or more axle flange 610 or an axle flange 610 may be absent. Additionally, the axle 310 may comprise various other structures, which facilitate locking within a portion of a magnetic turntable 100, coupling to a portion of a magnetic turntable 100, rotation of a portion of a magnetic turntable 100 about an axis of the axle 310, and the like.

In some embodiments, the axle 310 may comprise various materials such as metal, plastic, wood, a magnetized material and the like. In further embodiments, the axle 310 may comprise moving parts, bearings, coupling members, and the like.

In various embodiments it may be desirable to have the diameter of the axle 310 be broad in comparison to the smallest diameter of the top portion 110 because a broader axle may provide for smoother rotation therearound. For example, in various embodiments, the diameter of the axle 310 may be at least ½, ¼, ⅛, or various proportions of the smallest diameter of the top portion 110.

In some embodiments, a magnetic turntable 100 may further comprise a cover. For example, where the magnetic turntable 100 is used in conjunction with airbrushing, sandblasting, spray painting, splatter painting, and the like, there may be a cover that surrounds a portion of the magnetic turntable 100 so as to prevent or reduce paint or other particulate matter from traveling far from the magnetic turntable 100. In some exemplary embodiments, such a cover may be wrapped around the perimeter of the magnetic turntable 100 either partially or fully. In other exemplary embodiments, the cover may be perpendicular to the surface of the magnetic turntable 100, may be angled toward the center of the magnetic turntable 100, and the like.

Additionally, in some embodiments, a cutter tool may be associated with or coupled to the magnetic turntable. For example, there may be structures where a cutter can be coupled to the magnetic turntable 100, or a cutter may be coupled to the magnetic turntable via magnetism. Cutters may include various cutter types including sliding, rotational, scissor, arm cutters, and the like. A cutter may be a work tool 840 as depicted in the following Figures, and may be configured or designed to cut a workpiece 820 while affixed to the work face 150 or metallic top plate 340.

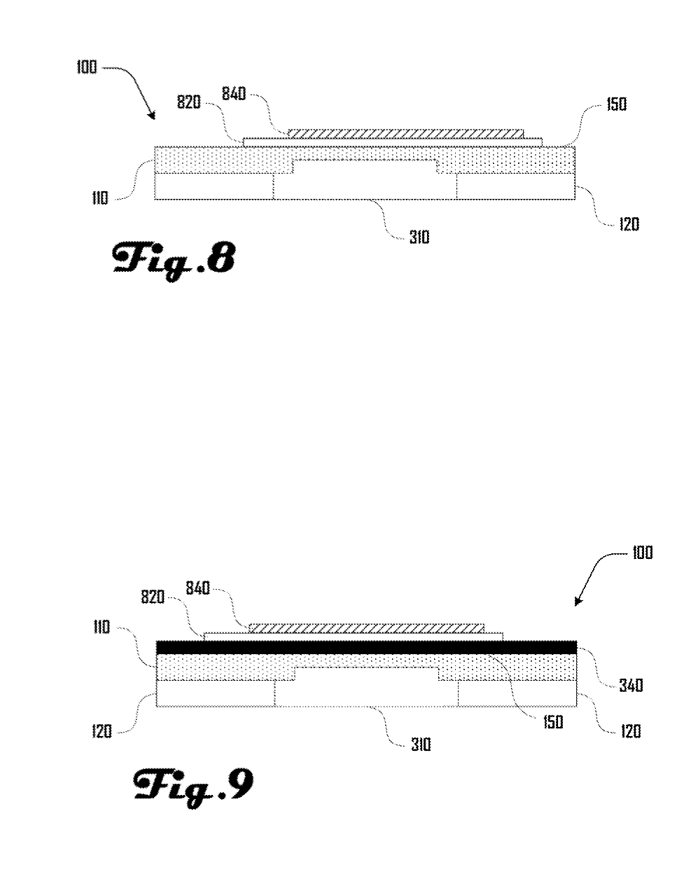

FIGS. 8 and 9 depict a magnetic turntable 100 holding a workpiece 820 with a work tool 840 in accordance with various embodiments. For example, in one embodiment, the magnetic turntable 100 can hold a piece of craft paper when a metal stencil or guide is positioned over the craft paper and magnetic attraction pins the craft paper to the magnetic turntable 100 via magnetic attraction of the metal stencil or guide and the magnetic turntable 100.

FIG. 8 is a side view of a magnetic turntable 100 in accordance with an embodiment, which comprises a top portion 110, a base portion 120 and an axle 310. As shown in FIG. 8, a part of the axle 310 may reside within the base portion 120, and a part of the axle 310 may reside within the coupling orifice 410 of the top portion 110. As discussed herein, the axle 310 facilitates rotation of the top portion 110 about the axle 310, and provides a rotational coupling of the top portion 110 and the bottom portion 120. Exemplary rotation is depicted in FIGS. 1a, 1b, 2a, and 2b.

Additionally, FIG. 8 depicts a workpiece 820 positioned on the work face 150 of the top portion 110 being held in place by a metallic or magnetic work tool 840. In various embodiments, the work tool 840 may be magnetically attracted to the magnetic top portion 110. Accordingly, the work tool 840 may comprise a metal or a magnet in various embodiments.

Similarly, FIG. 9 depicts a side view of a magnetic turntable 100 in accordance with an embodiment, which comprises a top portion 110, a base portion 120, a metallic top plate 340, and an axle 310. The metallic top plate 340 may be removable, yet securely coupled to the work face 150 of the top portion 110 via magnetism between the metallic top plate 340 and the magnetic top portion 110.

Additionally, FIG. 9 depicts a workpiece 820 positioned on the metallic top plate 340 and held on the top plate 340 via a work tool 840. In various embodiments, the work tool 840 may comprise a metal or a magnet which may be attracted to one of the magnetic top portion 110 or the metallic top plate 340. Accordingly, the workpiece 820 may be pinned to the top plate 340 via the work tool 840 when the work tool 840 is magnetically attracted to at least one of the metallic top plate 340 or the magnetic top portion 110.

In various embodiments, the work tool 840 may comprise a metal and/or a magnet. Additionally, the work tool 840 may include a ruler, a stencil, a mask, a die, and the like. While various embodiments include a planar work tool 840, further embodiments include metallic and/or magnetic work tools 840 of varying dimension, complexity, and functionality. For example, as discussed herein, a magnetic work tool 840 may include a cutter.

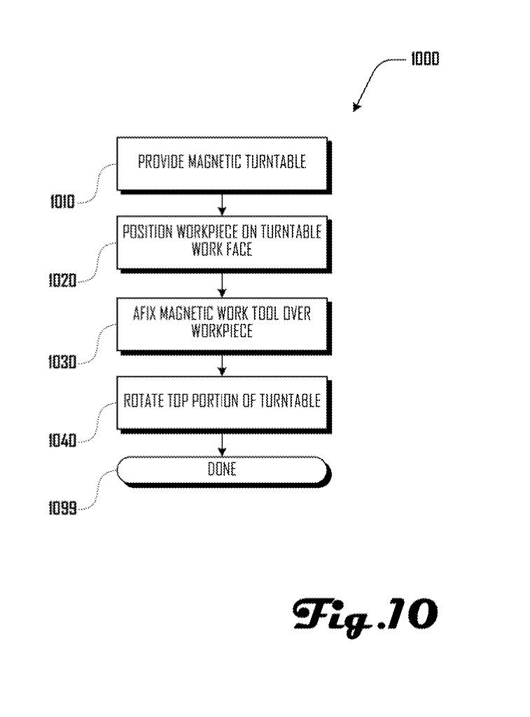

FIG. 10 is a block diagram depicting a method holding a workpiece 1000 in accordance with an embodiment. The method of holding a workpiece 1000 begins in block 1010 where a magnetic turntable 100 is provided. In block 1020, a workpiece 820 is positioned on the magnetic turntable 100 work face 150. In block 1030 a magnetic work tool 840 is affixed over the workpiece 820 and the workpiece 820 is pinned to the work face 150 via magnetism between the work tool 840 and the magnetic turntable 100. In block 1040, the top portion 110 of the magnetic turntable 100 is rotated. The workpiece holding method 1000 is then done in block 1099.

For example, in one embodiment, a user may desire to cut the paper workpiece 820 by positioning the paper workpiece 820 on the work face 150 of the magnetic turntable 100 and fixing the workpiece 820 to the work face 150 by positioning a metallic stencil work tool 840 in a desired position over the workpiece 820. The magnetic force holding the metallic stencil tool 840 may be sufficient to then allow the user to cut the paper workpiece 820 with a razor blade or other cutting tool along the edge of the metallic stencil tool 840. Similarly, a user could also use such a metallic stencil tool 840 as a guide when drawing or marking on the paper workpiece 820.

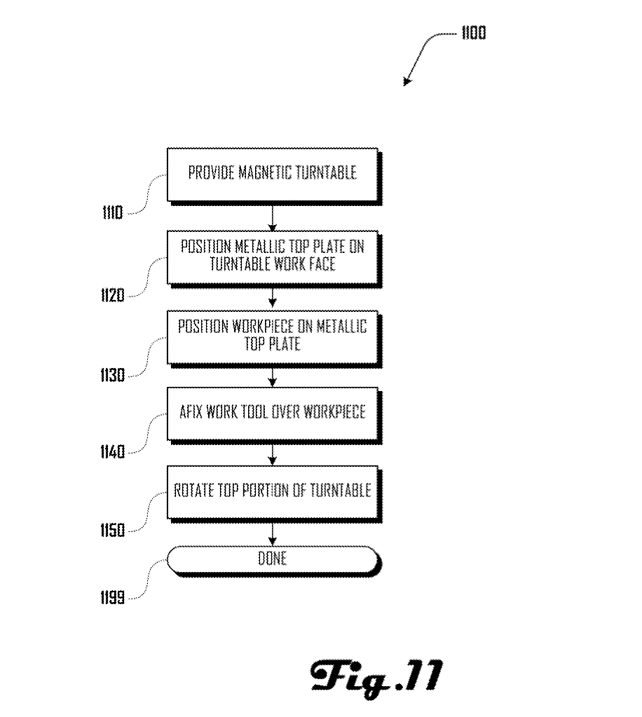

FIG. 11 depicts another workpiece holding method 1100 in accordance with an embodiment. The workpiece holding method 1100 begins in block 1110 where a magnetic turntable 100 is provided in block 1120 a metallic top plate 340 is positioned on the work face 150 of the magnetic turntable 100, where the metallic top plate 340 is coupled to the work face 150 of the magnetic turntable 100 via magnetism.

In block 1130, a workpiece 820 is positioned on the metallic top plate 340, and in block 1140 a work tool 840 is positioned over the workpiece 820 and thereby affixed to the metallic top plate 340 via magnetism. The work tool 840 may comprise a metal and/or a magnet, and may therefore be magnetically attracted to either the magnetic top portion 110 of the magnetic turntable 100 or the metallic top plate 340. In block 1150 the top portion 1110 of the magnetic turntable 100 is rotated and the workpiece holding method 1100 is done in block 1199.

For example, on one embodiment, a user may desire to draw a design on a workpiece 820 and may not have a stencil work tool 840 that is operable to be magnetically attracted to the top portion 110 the magnetic turntable 100, but it is operable to be magnetically attracted to a metallic top plate 340 which may be coupled to the work face 150 of the magnetic turntable 100.

Accordingly, in such an example a user may affix a metallic top plate 340 to the magnetic turntable 100 and then position a cardboard workpiece 820 on top of the metallic top plate 340. The user may then pin the cardboard workpiece 820 to the metallic top plate 340 by positioning the magnetic stencil work tool 840 in a desired location over the workpiece 820. The magnetic stencil work tool 840 may then be held magnetically to the metallic top plate 340 and the user may then draw a design on the cardboard workpiece 820 by moving a pencil or other drawing implement about the contours of the magnetic stencil work tool 840.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the embodiments described herein.

1. A method of holding a planar workpiece comprising:
providing a magnetic turntable comprising:
a substantially planar base portion having an axle positioned at and extending from a base central axis; and
a substantially uniformly magnetic planar top portion comprising:
a planar work face; and
an opposing planar coupling face having an axle orifice complementary to the axle and extending perpendicular to the opposing work face and coupling face, and positioned at top portion central axis,
wherein the top portion abuts the base portion about the coupling face with the axle residing within the axle orifice, thereby providing a rotational coupling between the base portion and top portion,
positioning a planar workpiece on the planar work face;
positioning a planar metallic tool on the workpiece whereby magnetism between the magnetic top portion and the planar metallic tool securely pins the planar workpiece to the planar work face; and
rotating the top portion about the rotational coupling.

2. The method of claim 1, wherein the rotational coupling provides for at least 360° rotation of the top portion about the axle.

3. The method of claim 1, wherein the axle and axle orifice are circular.

4. The method of claim 3, wherein the diameter of the axle and axle orifice are at least ⅛ of the smallest diameter of the top portion.

5. The method of claim 3, wherein the diameter of the axle and axle orifice are at least ¼ of the smallest diameter of the top portion.

6. The method of claim 1, wherein said top portion and bottom portion are substantially rectangular.

7. The method of claim 1, wherein the top portion comprises a substantially planar magnetic member defining the planar work face coupled to a coupling member defining the axle orifice.

8. The method of claim 7, wherein the coupling member is magnetic and wherein said magnetic member is coupled to the coupling member via magnetism.

9. The method of claim 1, further comprising coupling a cutting device to the top portion.

10. A method of holding a planar workpiece comprising:
providing a magnetic turntable comprising:
a substantially planar base portion having an axle positioned at and extending from a base central axis; and
a substantially uniformly magnetic planar top portion comprising:
a planar work face; and
an opposing planar coupling face having an axle orifice complementary to the axle and extending perpendicular to the opposing work face and coupling face, and positioned at top portion central axis,
wherein the top portion abuts the base portion about the coupling face with the axle residing within the axle orifice, thereby providing a rotational coupling between the base portion and top portion,
positioning a planar metallic top plate on the work face, whereby the top plate is coupled to the work face via magnetism;
positioning a planar workpiece on the top plate;
positioning a planar work tool on the workpiece whereby magnetism securely pins the planar workpiece to the top plate; and
rotating the top portion about the rotational coupling.

11. The method of claim 10, wherein the rotational coupling provides for at least 360° rotation of the top portion about the axle.

12. The method of claim 10, wherein the axle and axle orifice are circular.

13. The method of claim 12, wherein the diameter of the axle and axle orifice are at least ⅛ of the smallest diameter of the top portion.

14. The method of claim 12, wherein the diameter of the axle and axle orifice are at least ¼ of the smallest diameter of the top portion.

15. The method of claim 10, wherein said top portion and bottom portion are substantially rectangular.

16. The method of claim 10, wherein the top portion comprises a substantially planar magnetic member defining the planar work face coupled to a coupling member defining the axle orifice.

17. The method of claim 16, wherein the coupling member is magnetic and wherein said magnetic member is coupled to the coupling member via magnetism.

18. The method of claim 10, further comprising coupling a cutting device to the top portion.

19. The method of claim 10, wherein the work tool is metallic and not substantially magnetic, and wherein the work tool is coupled to the top plate via magnetism with the magnetic planar top portion.

20. The method of claim 10, wherein the work tool is magnetic, and wherein the work tool is coupled to the top plate via magnetism with the metallic top plate.
